(19) United States
(12) Patent Application Publication
(10) Pub. No.: US 2015/0183223 A1
(43) Pub. Date: Jul. 2, 2015

(54) FLUID STORAGE CONTAINER

(71) Applicant: Seiko Epson Corporation, Shinjuku-ku (JP)

(72) Inventor: Manabu YAMADA, Matsumoto-shi (JP)

(21) Appl. No.: 14/657,112

(22) Filed: Mar. 13, 2015

Related U.S. Application Data
(62) Division of application No. 12/730,131, filed on Mar. 23, 2010.

(30) Foreign Application Priority Data
Mar. 24, 2009 (JP) 2009-072123

(51) Int. Cl. B41J 2/175

(52) U.S. Cl. CPC B41J 2/17513

(57) ABSTRACT

A fluid storage container features outstanding impact resistance and stores a plurality of fluids. The fluid storage container has a case body, a cover, and another cover. The case body has a divider that isolates a waste ink storage unit and an ink pack storage unit, and perimeter walls formed around the divider, thus forming a recess on each side of the divider. The case body is open at the outside edge part of each perimeter wall. The one cover covers the open part of the perimeter wall on the waste ink storage unit side. The other cover covers the open part of the perimeter wall on the ink pack storage unit side. At least one corner of the case can be rendered by an inside wall and an outside wall disposed with a gap there between.

### CROSS-REFERENCES TO RELATED APPLICATIONS

This application is a divisional of U.S. patent application Ser. No. 12/730,131, filed Mar. 23, 2010, which claims the priority to Japanese Patent Application No. 2009-072123, filed Mar. 24, 2009, the contents of which are hereby incorporated by reference in their entireties.

### BACKGROUND

1. Technical Field

The present invention relates to a fluid storage container having a fluid storage unit in which fluid can be stored. The disclosed fluid storage container may be particularly well suited for use with a printing device to store ink supplied to the printing device and to store waste ink received from the printing device.

2. Description of Related Art

A printing device that prints using liquid ink is one example of a device that handles a fluid. An example of such a printing device is an inkjet printer that prints by supplying ink from a removable ink cartridge to a recording head, and then discharging ink droplets onto paper by means of the recording head.

One type of ink cartridge that can be used in such printing devices has a cover and a case body that is divided into separate storage areas for an ink pack in which ink is held and for a waste ink sponge for absorbing waste ink. For example, Japan Patent No. 3533897 discloses such an ink cartridge.

Ink cartridges that store an ink pack and an ink cartridge inside the cartridge case are also known from the literature. For example, Japanese Unexamined Patent Appl. Pub. JP-A-2002-307705 and Japanese Unexamined Patent Appl. Pub. JP-A-2002-307720 disclose such ink cartridges.

A problem with ink cartridges that store ink packs holding ink and a waste ink sponge that absorbs waste ink or a waste ink pack in a main case body is that the width of the side wall part of the main case body may be of sufficient size such that assuring sufficient strength is difficult.

As a result, when such an ink cartridge is dropped or subject to impact, cracks or other damage may occur in the case body and the ink stored within may leak out.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Fluid storage containers and waste fluid storage compartments are disclosed. A fluid storage container disclosed herein provides outstanding shock resistance and can store plural types of fluid. A waste fluid storage compartment disclosed herein can be placed into a first orientation to facilitate reception of a waste fluid into the storage compartment and into a second orientation to facilitate the removal of the waste fluid from the storage compartments. Such storage containers and storage compartments may be particularly beneficial when used in conjunction with printing devices to store ink supplied to the printing device and/or to store waste ink received from the printing device.

Thus, in a first aspect, a fluid storage container is disclosed. The fluid storage container has a first fluid storage unit in which fluid can be stored isolated from a second fluid storage unit in which fluid can be stored. The container includes a case body that includes a divider that isolates the first fluid storage unit and the second fluid storage unit. A recess is formed on each side of the divider by a perimeter wall formed around the divider on the first fluid storage unit side and a perimeter wall formed around the divider on the second fluid storage unit side. Each recess is open at the edge part of each perimeter wall. The container includes a first cover that covers the open part of the perimeter wall on the first fluid storage unit side and a second cover that covers the open part of the perimeter wall on the second fluid storage unit side. In many embodiments, at least one corner part of the perimeter wall of the case body includes an inside wall and an outside wall formed with a gap there between.

Such a fluid storage container can have a first fluid storage unit disposed on a first side of the divider and a second fluid storage unit disposed on opposite sides of a divider, and can therefore store, for example, different types of fluids in the first and second fluid storage units. For example, ink for supply to a printing device can be stored in the first fluid storage unit and waste ink received from the printing device can be stored in the second fluid storage unit.

Furthermore, because the case body of the fluid storage container in which the recessed first and second fluid storage units are formed on opposite sides of the divider can have an I-beam shape in cross section with a perimeter wall surrounding the divider, the width of the parts of the perimeter walls forming the fluid storage units can be reduced and the strength of the case body can be greatly increased. Damage to the case body when the fluid storage container is dropped or subject to impact can therefore be suppressed. And leakage of fluid from the first and/or second fluid storages unit may be prevented.

Furthermore, even if the outside wall is damaged as a result of the fluid storage container being dropped or struck, damage to the inside wall can be suppressed by the outside wall absorbing the impact. Therefore, leakage of fluid from the first and/or second fluid storage units may be prevented.

In many embodiments, the inside and outside walls of the perimeter wall are connected except at the corners of the case body by a plurality of perimeter wall connecting units disposed around the circumference with a gap there between. Such a fluid storage container has a gap rendered in the corners of the case body in anticipation of damage to the outside wall if the fluid storage container is dropped. Because positions other than the corners are less susceptible to impact than the corners, the inside and outside walls can be connected by perimeter wall connecting units at those positions to achieve both improved strength and prevent ink leakage.

In many embodiments, a fluid storage container has a connecting unit that connects a surface of the divider and a surface of the inner wall of the perimeter wall in at least one of the first or second fluid storage units. By providing a connecting unit in a fluid storage container, the perimeter wall is supported by the divider through the intervening connecting unit and the divider is supported by the perimeter wall through the intervening connecting unit. The divider and perimeter wall are therefore more resistant to deformation when a large mass of fluid is stored in the first or second fluid storage units.

In many embodiments, the connecting unit is disposed between the divider and the perimeter wall on a bottom side of the storage container when the fluid storage container is oriented to supply fluid from the fluid storage container. The side of the perimeter wall that is down when the fluid is used may be more easily deformed because the load from the mass of stored fluid is greater. By adding a connecting unit between the perimeter wall and the divider in the fluid storage container on the bottom side of the storage container as oriented to supply fluid from the storage container, the strength of the perimeter wall is increased and the perimeter wall is more resistant to deformation.

In many embodiments a plurality of said connecting units are disposed in a row, and said connecting units can be connected together by a connection reinforcement unit formed on the divider. Because the part of the divider supporting the perimeter wall through the connecting ribs may conceivably flex easily, a connection reinforcement unit that interconnects the connecting units and is disposed to the divider may help to suppress deformation resulting from the divider flexing.

In many embodiments, a fluid storage container includes a device that stores data that is disposed to an outside surface of the case body, and the divider is disposed within the range of the width of the device. When a reader/writer that reads and writes data to the device, for example, contacts and energizes the device, the load from the reader/writer can be received and absorbed by the divider in the fluid storage container. As a result, the load on the perimeter wall of the case body can be minimized, deformation of or damage to the perimeter wall by the load can be suppressed, and fluid leakage from the first and/or second fluid storage units may be prevented.

In another aspect, a fluid storage container is disclosed that has a first fluid storage compartment in which fluid can be stored isolated from a second fluid storage compartment in which fluid can be stored. The container includes a case body, a first removable cover, and a second removable cover. The case body includes a divider that blocks fluid communication between the first and second fluid storage compartments, a first perimeter wall comprising an inner wall and an outer wall spaced apart from the inner wall, and a second perimeter wall comprising an inner wall and an outer wall spaced apart from the inner wall. The first perimeter wall is disposed around a perimeter portion of the divider on a first side of the divider. The divider and the first perimeter wall define a first recess that partially defines the first fluid storage compartment. The second perimeter wall is disposed around a perimeter portion of the divider on a second side of the divider opposite to the first side of the divider. The divider and the second perimeter wall define a second recess that partially defines the second fluid storage compartment. The first cover and the first recess define the first fluid storage compartment when the first cover is coupled with the case body. And the second cover and the second recess define the second fluid storage compartment when the second cover is coupled with the case body.

In many embodiments, at least one of the first or second perimeter walls define a corner where the inside and outside walls are separated by a gap there between. The inside and outside walls of at least one of the first or second perimeter walls can be connected by a plurality of perimeter wall connecting units intermittently disposed along the perimeter wall.

In many embodiments, a fluid storage container includes at least one connecting rib that connects a surface of the divider and a surface of the inner wall in at least one of the first or second fluid storage compartments. The at least one connecting rib can be disposed on a bottom side of the container when the container is oriented to supply fluid. A plurality of the connecting ribs can be disposed in a row and can be connected together by a connection reinforcement unit formed on the divider.

In many embodiments, a fluid storage container includes a device having a width and storing data disposed to an outside surface of the case body. The divider can be connected to a portion of the case body partially defined by the outside surface within the width of the device. Such a configuration places the divider to help support the case body against deflection induced by external loads placed on the storage device, for example, by external loads arising from contact between the device and contact leads of a printing device.

In many embodiments, a fluid storage container is configured to couple with a printing device. For example, the fluid storage container can be used to store ink for supply to the printing device and can be used to store waste ink received from the printing device.

In another aspect, a waste fluid storage compartment is disclosed that has a first orientation to facilitate reception of a fluid into the storage compartment and a second orientation to facilitate removal of the fluid from the storage compartment. The storage compartment includes a case body and a cover coupled with the case body. The combination of the case body and the cover at least partially defines the storage compartment. At least one of the cover or the case body comprises a plurality of walls extending between the cover and the case body to divide the storage compartment so as to define an inlet channel having a first end and a second end, a recess disposed along a second side of the storage compartment opposite to the first side of the storage compartment, a fluid collection chamber in fluid communication with the recess and disposed at least partially below the recess when the storage compartment is in the first orientation and disposed generally above the recess when the storage compartment is in the second orientation, and a series of buffer chambers in fluid communication with the recess and disposed generally above the recess when the storage compartment is in the first and second orientations. The first end of the inlet channel is in fluid communication with a fluid port disposed along a first side of the storage compartment. The inlet channel is configured to transport the fluid received at the first end and discharge the fluid at the second end when the storage compartment is in the first orientation. The second end of the inlet channel is disposed within the recess. The buffer chambers are in fluid communication with an air escape hole to vent the storage compartment.

In many embodiments, each of a plurality of the buffer chambers is in fluid communication with an adjacent chamber of the buffer chambers via a vent hole disposed in one of the walls disposed between the chambers. One of the vent holes can be disposed above another of the vent holes when the storage compartment is in the first orientation. The walls can have a thickness dimension that extends between a surface of the case body and a surface of the cover and two of the vent holes can be disposed at different thickness dimensions.

In many embodiments, the cover can include one or more vent channels. Each vent channel can place one of the buffer chambers in fluid communication with another of the buffer chambers.

In many embodiments, the plurality of walls defines a plurality of ribs disposed in the fluid collection chamber. The ribs can be substantially horizontally oriented and configured to impede flow of the fluid from the fluid collection chamber to the buffer chamber when the storage compartment is in the first orientation while allowing the fluid to flow from the fluid collection chamber to the recess when the storage compartment is in the second orientation.

In many embodiments, the air escape hole is disposed near the bottom of the storage compartment when the storage compartment is in the first orientation. The plurality of walls can define an outside air channel disposed along a perimeter of the storage compartment that places the buffer chambers in fluid communication with the air escape hole. The plurality of walls can define a second fluid collection chamber in fluid communication with the outside air channel via an opening disposed at the top of the second fluid collection chamber when the storage compartment is in the first orientation. The plurality of walls can define a third fluid collection chamber in fluid communication with the outside air channel via an opening disposed at the top of the third fluid collection chamber when the storage compartment is in the first orientation. In many embodiments, the plurality of walls is integral to the cover.

In many embodiments, the storage compartment is configured to couple with a printing device. The storage compartment can store waste ink from the printing device.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view of an inkjet printer in which an ink cartridge is installed, in accordance with many embodiments.

FIG. 2 is an oblique view of the inkjet printer of FIG. 1 with the printer case removed.

FIGS. 3A and 3B are oblique views of an ink cartridge that can be installed in the inkjet printer of FIG. 1, in accordance with many embodiments.

FIG. 4 is an exploded oblique view from the right side of the ink cartridge of FIGS. 3A and 3B.

FIG. 5 is an exploded oblique view from the left side of the ink cartridge of FIGS. 3A and 3B.

FIG. 6 is a section view of the case body of the ink cartridge of FIGS. 3A and 3B.

FIG. 7 is a side view of part of the case body of the ink cartridge of FIGS. 3A and 3B.

FIG. 8 is a section view of part of the case body of the ink cartridge of FIGS. 3A and 3B.

FIG. 9 is section view showing the internal structure of the ink cartridge of FIGS. 3A and 3B.

FIG. 10A is a section view of the ink cartridge of FIGS. 3A and 3B through line A-A and FIG. 10B is a section view through line B-B shown in FIG. 9.

FIG. 11 is a section view of the ink cartridge of FIGS. 3A and 3B when positioned for a fluid removal operation, in accordance with many embodiments.

FIGS. 12A and 12B illustrate a case body of another ink cartridge, in accordance with many embodiments.

FIG. 13 is a section view of the case body of FIGS. 12A and 12B through line C-C shown in FIG. 12A.

FIG. 14 is an oblique view of the case body of FIGS. 12A and 12B from the ink pack storage unit side.

### DETAILED DESCRIPTION

In the following description, various embodiments of the present invention will be described. For purposes of explanation, specific configurations and details are set forth in order to provide a thorough understanding of the embodiments. However, the present invention can be practiced without the specific details. Furthermore, well-known features may be omitted or simplified in order not to obscure the embodiment being described.

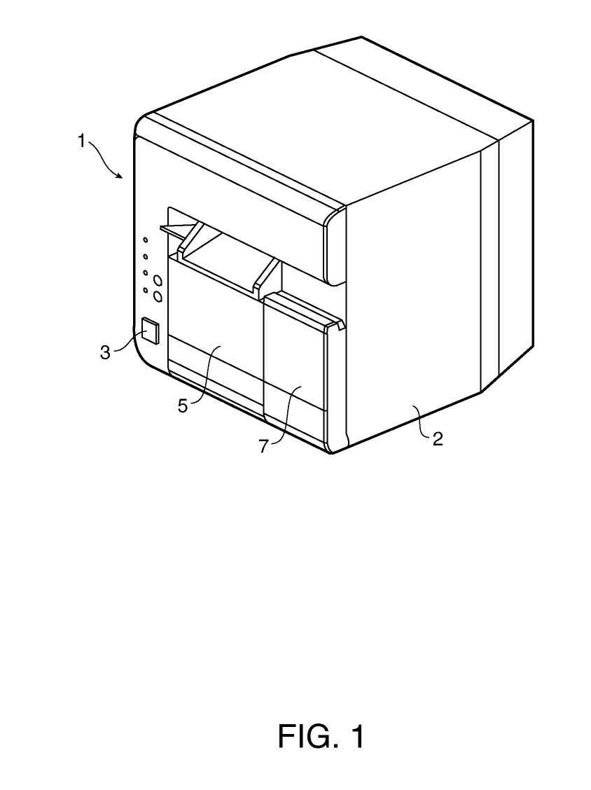

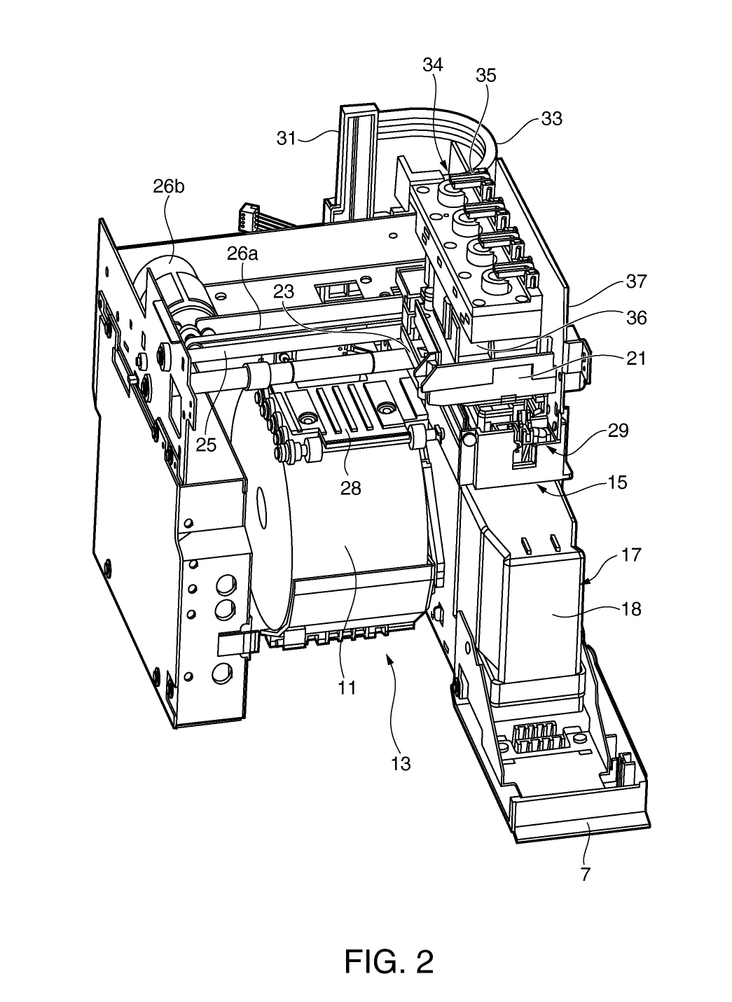

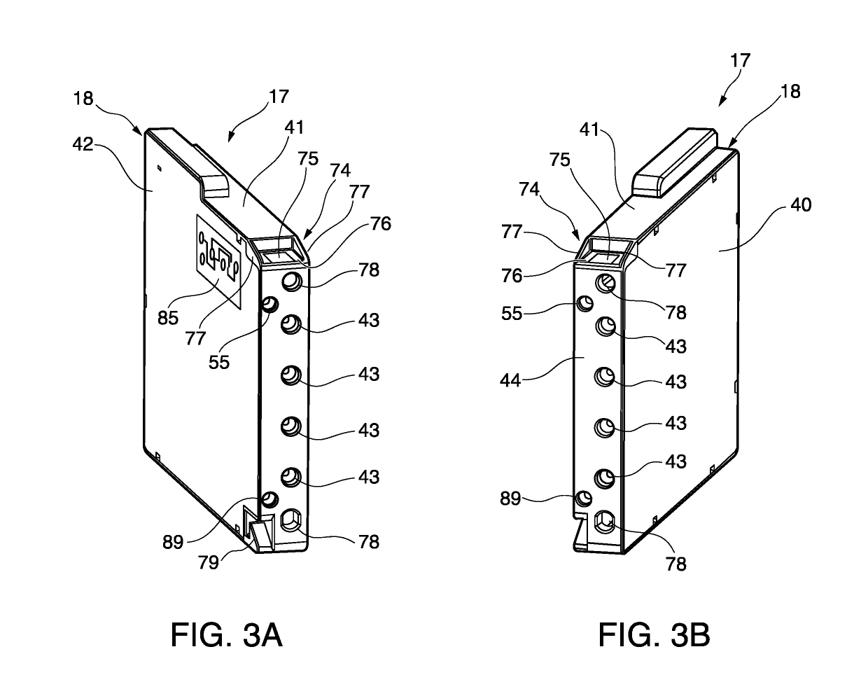

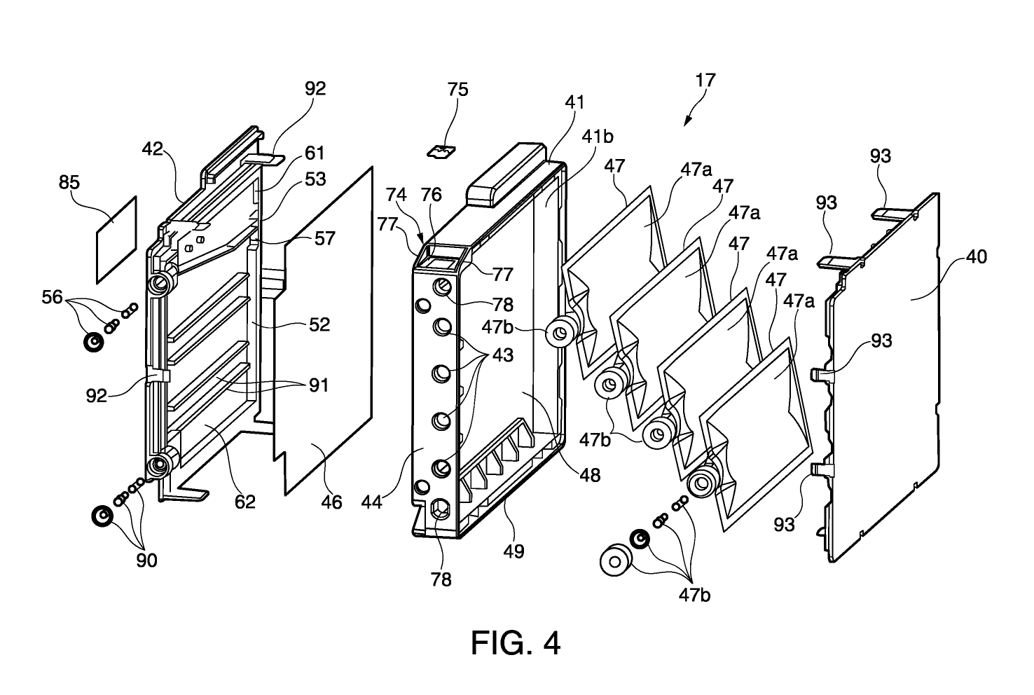

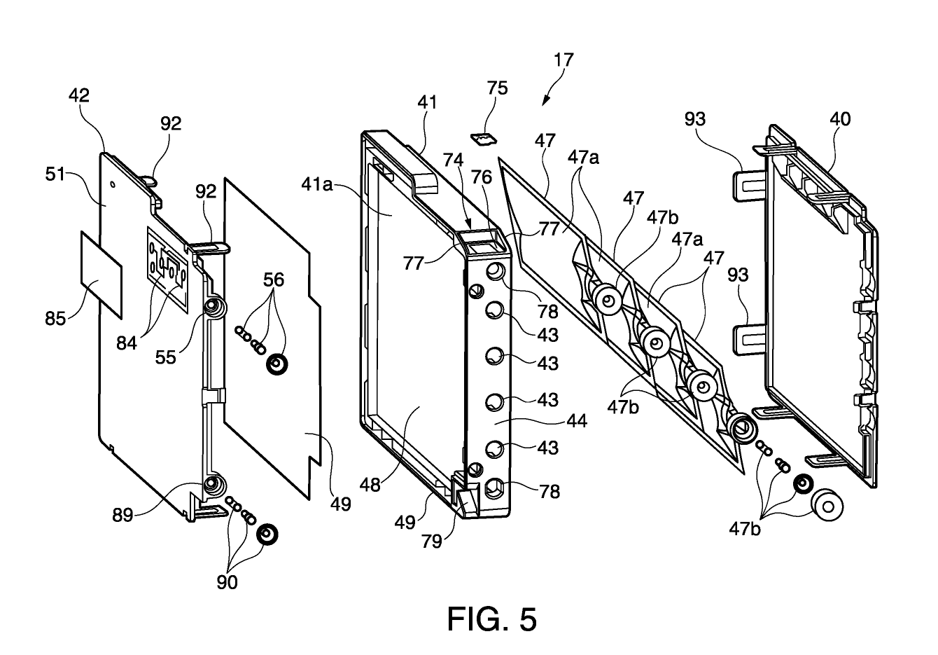

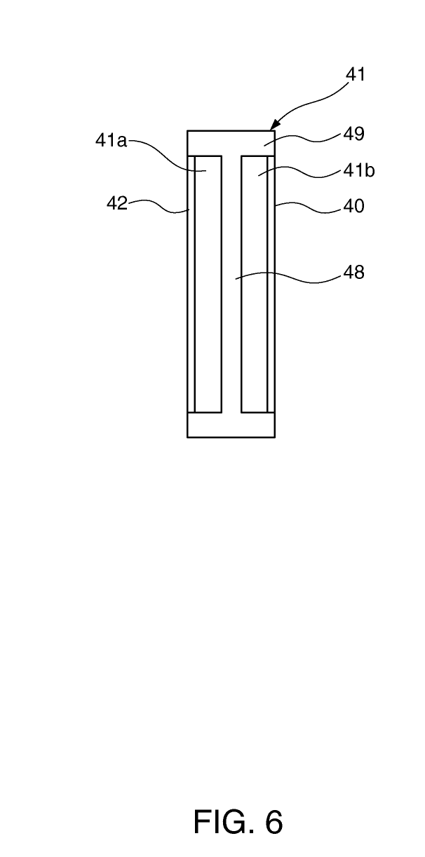

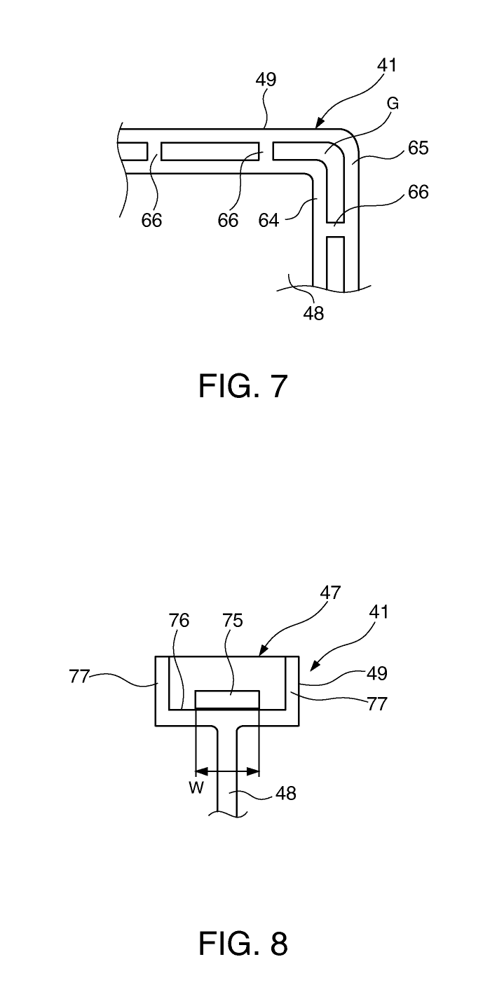

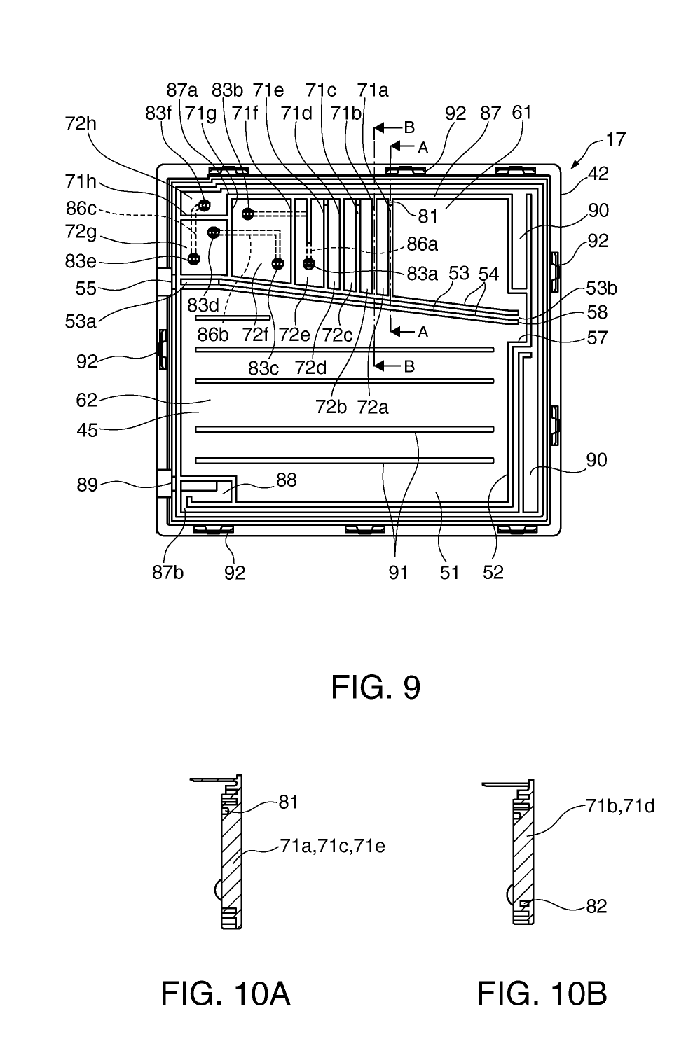

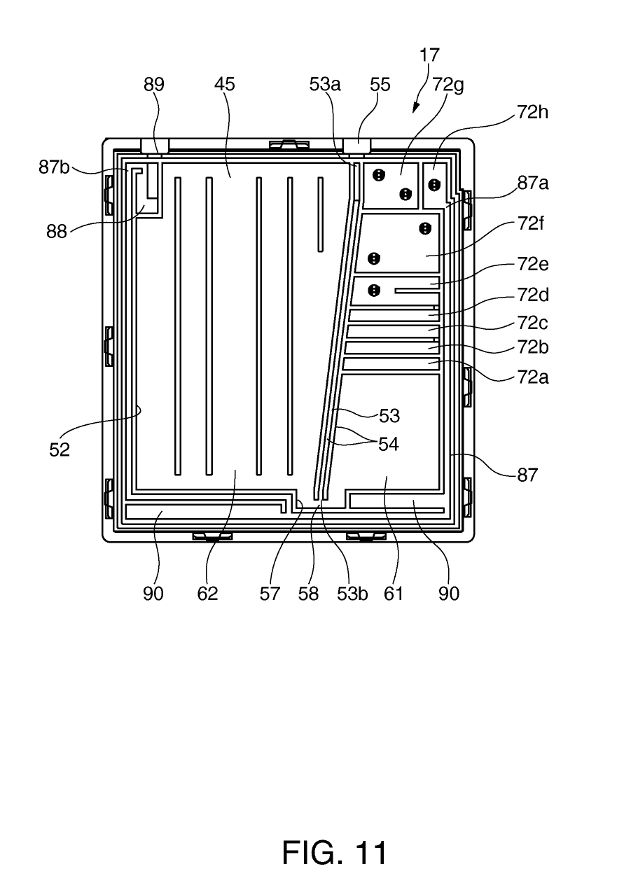

Referring now to the drawings, in which like reference numerals represent like parts throughout the several views, FIG. 1 is an oblique view of an inkjet printer in accordance with many embodiments in which an ink cartridge, which is a fluid storage container according to the invention, is installed. FIG. 2 is an oblique view of the inkjet printer with the printer case removed. FIG. 3A and FIG. 3B are oblique views of an ink cartridge in accordance with many embodiments. FIG. 4 is an exploded oblique view of the ink cartridge from the right side. FIG. 5 is an exploded oblique view of the ink cartridge from the left side. FIG. 6 is a section view of the case body of the ink cartridge. FIG. 7 is a side view of a corner part of the case body of the ink cartridge. FIG. 8 is a section view of part of the case body of the ink cartridge where a device storing data is attached. FIG. 9 is section view showing the internal structure of the ink cartridge. FIG. 10A is a section view through line A-A and FIG. 10B is a section view through line B-B shown in FIG. 9. FIG. 11 is a section view of the ink cartridge when positioned for a fluid removal operation.

The construction of an inkjet printer in which the ink cartridges disclosed herein can be used is described first below.

FIG. 1 illustrates an inkjet printer 1 that can use a plurality of different colors of ink to print in color on part of a recording paper delivered from a roll of paper. The roll of paper is disposed behind a roll paper cover 5. An ink cartridge cover 7 is disposed to open and close freely at the front of the printer case 2 that covers the printer assembly. A power switch 3, paper feed switch, and indicators are also disposed to the front of the printer case 2.

Opening the roll paper cover 5 opens a paper compartment 13 in which the roll paper (medium) 11 used as the print medium is stored as shown in FIG. 2 so that the roll paper 11 can be replaced.

Opening the ink cartridge cover 7 opens a cartridge loading unit 15, enabling installing and removing of an ink cartridge 17 (fluid storage container) in the cartridge loading unit 15.

In many embodiments, opening the ink cartridge cover 7 also causes the ink cartridge 17 to be pulled a specific distance forward in front of the cartridge loading unit 15.

A carriage 23 on which an inkjet head 21 is mounted is disposed above the paper compartment 13 inside the printer case 2. The carriage 23 is supported to move freely widthwise to the paper by means of a guide member 25 that extends widthwise to the roll paper 11, and can be moved bidirectional widthwise to the roll paper 11 above a platen 28 by means of an endless belt 26a disposed widthwise to the roll paper 11 and a carriage motor 26b that drives the endless belt 26a. The inkjet head 21 prints by discharging ink to part of the recording paper delivered from the roll paper 11.

As illustrated in FIG. 2, the standby position (home position) of the bidirectional moving carriage 23 is above the cartridge loading unit 15. An ink vacuum mechanism 29 that vacuums ink from inside the ink nozzles of the inkjet head 21 exposed below the carriage 23 is disposed below this standby position.

The ink cartridge 17 stores a plurality of color ink packs 47 (shown in FIG. 4) inside a cartridge case 18. Each of the ink packs 47 inside the ink cartridge 17 is made of a flexible material and is sealed with ink stored inside. When the ink cartridge 17 is loaded into the cartridge loading unit 15, an ink supply needle (not shown in the figure) disposed on the cartridge loading unit 15 side is inserted to and connects with a below-described ink supply opening 43 of the ink pack 47. An ink path 31 fixed inside the printer case 2 is connected to the ink supply needle of the cartridge loading unit 15, and one end of a flexible ink supply tube 33 having a channel for each color is connected to the ink path 31.

The other end of the ink supply tube 33 is connected to an ink pump unit 34 disposed to the carriage 23 for each color. Each ink pump unit 34 is disposed above the inkjet head 21, and connected to the self-sealing unit 36 connected to the inkjet head 21.

In addition to the inkjet head 21, the ink pump unit 34 and the self-sealing unit 36 are disposed in unison with the carriage 23.

As a result, ink from each ink pack inside the ink cartridge 17 is supplied to the ink nozzles of the inkjet head 21 from the ink supply needle of the cartridge loading unit 15 through the ink path 31, the ink supply tube 33, the ink pump unit 34 for each color, and the self-sealing unit 36 for each color.

The ink pump unit 34 pulls ink from the ink cartridge 17 as a result of carriage 23 movements. A regulator panel 37 that causes the ink pump unit 34 to operate by movement of the carriage 23 is disposed in front of the direction of carriage 23 movement to the standby position.

When the rocker arm 35 of the ink pump unit 34 contacts the regulator panel 37 as a result of the carriage 23 moving to the standby position, the rocker arm 35 rocks and drives the internal pump. As a result, ink is drawn from the ink cartridge 17.

Ink vacuumed from the inkjet head 21 by the ink vacuum mechanism 29 when cleaning the inkjet head 21 is returned to the ink cartridge 17 as waste ink.

The ink cartridge 17 that is installed in the cartridge loading unit 15 of the foregoing inkjet printer 1 is described next.

As shown in FIG. 3A to FIG. 5, the ink cartridge 17 has a cartridge case 18. The cartridge case 18 has a case body 41 and covers 40 (first cover) and 42 (second cover) that are attached to opposite sides of the case body 41.

As shown in FIG. 6, the case body 41 has a divider 48 in the middle of the case thickness, and a perimeter wall 49 is formed around and in unison with the divider 48. When seen in section, the case body 41 thus has an I-beam shape with a recess on both sides. One side of the case body 41 is a waste ink storage unit 41a (second fluid storage unit). The other side is an ink pack storage unit 41b (second fluid storage unit). And the case body 41 is open at the edge part of the perimeter wall 49 rendering the waste ink storage unit 41a and ink pack storage unit 41b.

The outside opening of the perimeter wall 49 on the ink pack storage unit 41b side of the case body 41 thus configured is covered and closed by one cover 40. And the outside opening of the perimeter wall 49 on the waste ink storage unit 41a side is covered and closed by the other cover 42.

As shown in FIG. 7, the perimeter wall 49 of the case body 41 has an inside wall 64 on the divider 48 side, and an outside wall 65 disposed with a gap between it and the inside wall 64. The inside wall 64 and outside wall 65 are connected together by ribs 66 (perimeter wall connecting units) spaced with gaps there between around the circumference. In many embodiments, the ribs 66 are disposed at positions not including the corners of the case body 41, and a gap G is thus formed between the inside wall 64 and outside wall 65 at the corners of the case body 41.

In many embodiments, at one of the outside surfaces of the case body 41 is an installation face 44. A recess is formed in the top part of the case body 41 on the installation face 44 side, and this recess renders a chip holding unit 74. As shown in FIG. 8, the chip holding unit 74 has an installation surface 76 to which a device, for example, an integrated circuit (IC) chip 75, is affixed and a reinforcing rib 77 is formed on both sides of the installation surface 76.

A reader/writer (not shown in the figure) disposed to the inkjet printer 1 reads and writes data to the IC chip 75 attached to the installation surface 76 of the chip holding unit 74. The IC chip 75 can store information such as the ink consumption volume, remaining ink volume, waste ink volume, date of first use, and information about the device in which the ink cartridge is used. In many embodiments, the divider 48 rendered in the case body 41 is disposed within the range W of the width of the IC chip 75 mounted on the installation surface 76.

A guide hole 78 is formed in the installation face 44 near the top and the bottom ends of the installation face 44. An engaging claw 79 is formed at the bottom part of the case body 41 on the installation face 44 side. When the ink cartridge 17 is loaded into the cartridge loading unit 15 of the inkjet printer 1, guide pins (not shown in the figure) disposed to the cartridge loading unit 15 enter into the guide holes 78 and position the ink cartridge 17. A cam (not shown in the figure) disposed to the cartridge loading unit 15 also engages the engaging claw 79, and the ink cartridge 17 is thus locked into the cartridge loading unit 15.

When the ink cartridge 17 is thus loaded into the cartridge loading unit 15, a contact (not shown in the figure) of the reader/writer disposed on the inkjet printer 1 side is pressed against and contacts the contacts of the IC chip 75 disposed to the chip holding unit 74. Data can thus be read and written to the IC chip 75.

Ink packs 47 containing various colors of ink are stored inside the ink pack storage unit 41b of the case body 41. Each ink pack 47 has a sack part 47a that contains ink, and a valve part 47b that is disposed to the end part of the sack part 47a. The ink packs 47 are stored with the sack parts 47a overlapping inside the ink pack storage unit 41b. And the valve part 47b of each ink pack 47 is connected to an ink supply opening 43 disposed in the installation face 44.

A plurality of locking tabs 93 for engaging matching catches (not shown in the figure) formed on the case body 41 side are formed around the perimeter of the one cover 40 that covers the ink pack storage unit 41b. As a result, when the cover 40 is assembled to the case body 41, the locking tabs 93 engage the catches so that the cover 40 is affixed to the case body 41.

An ink storage unit 45 in which waste ink is collected is formed in the ink cartridge 17 on the other cover 42 side. The ink storage unit 45 is formed by the cover 42 and a film 46 affixed to the cover 42.

The cover 42 has a flat panel 51 formed to be substantially flat, and a frame part 52 rising from around the edge of the flat panel 51. A high rigidity film 46 is affixed so that it covers the frame part 52, and the ink storage unit 45 is thus formed in the cover 42.

As shown in FIG. 9, an ink path (fluid path) 53 extending side to side is formed on the top side of the vertical center in the ink storage unit 45. The orientation of the ink cartridge 17 shown in FIG. 9 is the orientation when the ink cartridge 17 is installed in the cartridge loading unit 15, and waste ink is guided into the ink storage unit 45 in this orientation.

The ink path 53 is formed by the flat panel 51, a pair of wall parts 54 that rise from the flat panel 51, and the film 46. One end 53a of the ink path 53 is open at the installation face 44, and the other end 53b is open near the frame part 52 on the opposite side as the installation face 44. The one end 53a of the ink path 53 that is opened at the installation face 44 communicates with the ink inlet/outlet 55 formed in the installation face 44. A valve 56 that opens when the ink discharge needle (not shown in the figure) is inserted is disposed in the ink inlet/outlet 55. A recess 57 that is recessed toward the outside is formed in the frame part 52 at a position near the other end 53b of the ink path 53. The other end 53b of the ink path 53 is disposed opening into the recess 57.

The ink storage unit 45 in which the ink path 53 is formed is divided by the ink path 53 into an air chamber 61 in the top part and a fluid chamber 62 in the bottom part. A gap between the ink path 53 and the bottom of the recess 57 renders a communication path 58 between the air chamber 61 and the fluid chamber 62. Because the ink path 53 is formed above the vertical center in the top part of the ink storage unit 45, the fluid chamber 62 is larger than the air chamber 61.

The ink path 53 is also formed sloping gradually downward from the one end 53a on the installation face 44 side to the other end 53b on the recess 57 side. The ink path 53 thus slopes down toward the fluid chamber 62 from the one end 53a to the other end 53b.

A plurality of buffer chambers 72a to 72h separated from each other by a plurality of dividers 71a to 71h rising from the flat panel 51 is formed in the air chamber 61 side in an area on the opposite side as the communication path 58.

As shown in FIG. 10A, dividers 71a, 71c, 71e have a vent hole 81 rendered by a channel formed on the film 46 side and the film 46, and dividers 71b, 71d have a vent hole 82 formed on the flat panel 51 side as shown in FIG. 10B. Note that the plural dividers 71a to 71g are formed substantially parallel to the direction the waste ink flows from the fluid chamber 62 to the air chamber 61 in the communication path 58.

The vent holes 81 are disposed in the top part of the air chamber 61, and the vent holes 82 are formed in the bottom part of the air chamber 61. As a result, buffer chamber 72a communicates near the top with the space on the communication path 58 side, buffer chamber 72b communicates with the buffer chamber 72a near the bottom, buffer chamber 72c communicates with the buffer chamber 72b near the top, buffer chamber 72d communicates with the buffer chamber 72c near the bottom, and buffer chamber 723 communicates with the buffer chamber 72d near the top. The vent holes 81 and 82 are formed at different positions in the thickness direction of the ink cartridge 17.

A hole 83a is formed in the flat panel 51 in buffer chamber 72e. A pair of holes 83b and 83c is formed in the flat panel 51 in the buffer chamber 72f. A pair of holes 83d and 83e is formed in the flat panel 51 in the buffer chamber 72g. And one hole 83f is formed in the flat panel 51 in the buffer chamber 72h.

As shown in FIG. 5, a plurality of channel parts 84 are formed in the flat panel 51 on the opposite side as the ink storage unit 45. A rigid transparent film 85 is applied to the flat panel 51 on the opposite side as the ink storage unit 45 so that the transparent film 85 covers the channel parts 84. As a result, a plurality of air channels 86a, 86b, 86c rendered by the channel parts 84 and transparent film 85 are formed in the flat panel 51 on the opposite side as the ink storage unit 45.

Air channel 86a communicates with the hole 83a in the buffer chamber 72e and the hole 83b in the buffer chamber 72f. Air channel 86b communicates with the hole 83c in the buffer chamber 72f and the hole 83d in the buffer chamber 72g. And the air channel 86c communicates with the hole 83e in the buffer chamber 72g and the hole 83f in the buffer chamber 72h.

An outside air channel 87 is formed near the periphery of the ink storage unit 45 passing along the top side, the opposite side as the installation face 44, and the bottom side. One end 87a of the outside air channel 87 communicates with buffer chamber 72h in the air chamber 61. And the other end 87b communicates with an air release chamber 88 that is formed in the bottom on the installation face 44 side. An air escape hole 89 connected to the air release chamber 88 is formed in the installation face 44 at a position near the bottom of the ink cartridge. The outside air channel 87 is thus open to outside air through the air escape hole 89. As a result, the outside air channel 87 that communicates with the air chamber 61 and the atmosphere is rendered with the other end 87b on the air escape side at a position farther from the air chamber 61 than the fluid chamber 62. Note that a valve 94 that opens when an air injection needle (not shown in the figure) is inserted is disposed to the air escape hole 89.

Two fluid collection chambers 90 that are open at the top are formed in the middle of the outside air channel 87 on the opposite side as the installation face 44.

A plurality of ribs 91 are formed rising from the flat panel 51 in the fluid chamber 62 of the ink storage unit 45. The ribs 91 are disposed substantially horizontal and mutually parallel in the direction impeding the flow of waste ink from the fluid chamber 62 to the air chamber 61 through the communication path 58, and maintain space between the flat panel 51 and the film 46.

A plurality of engaging tabs 92 capable of engaging catch parts (not shown in the figure) formed on the case body 41 side are formed around the outside edge of the flat panel 51 of the cover 42. As a result, when the cover 42 is assembled to the case body 41, the engaging tabs 92 engage the catches, and the cover 42 is thereby attached to the case body 41.

When the ink cartridge 17 thus configured is installed to the cartridge loading unit 15 of the inkjet printer 1, the ink supply needles disposed on the cartridge loading unit 15 side are inserted to the ink supply openings 43 and ink of each color can be supplied to the inkjet printer 1 side.

In addition, when the ink cartridge 17 is installed in the cartridge loading unit 15, the ink discharge needle disposed on the cartridge loading unit 15 side is inserted to the ink inlet/outlet 55. As a result, waste ink discharged by cleaning the inkjet head 21 is fed through the ink discharge needle to the ink inlet/outlet 55. The waste ink fed to the ink inlet/outlet 55 passes through the ink path 53, is fed from the other end 53b of the ink path 53 into the ink storage unit 45, and is collected in the fluid chamber 62.

Because the ink path 53 slopes down to the fluid chamber 62 side from the one end 53a on the ink inlet/outlet 55 side to the other end 53b that opens inside the recess 57, waste ink that is fed to the ink inlet/outlet 55 flows smoothly along the slope in the ink path 53, is guided into the ink storage unit 45, and is collected in the fluid chamber 62.

When the waste ink is fed as described above, the air inside the ink storage unit 45 is pushed by the inflowing waste ink from the communication path 58 side through the sequentially communicating buffer chambers 72a to 72h into the outside air channel 87 by means of the vent holes 81 and 82 and the air channels 86a to 86c, and is then guided by the outside air channel 87 into the air release chamber 88 and discharged to the outside from the air escape hole 89. The internal pressure of the ink storage unit 45 therefore does not rise even when waste ink flows in. As a result, the waste ink that is fed through the ink discharge needle is guided smoothly to the ink storage unit 45 without backflow caused by internal pressure.

The used ink cartridge 17 is then removed from the cartridge loading unit 15 of the inkjet printer 1 after the ink in the ink packs 47 is depleted. As a result, the ink supply needles on the cartridge loading unit 15 side are pulled out from the ink supply openings 43 of the ink packs 47, and the ink discharge needle on the cartridge loading unit 15 side is pulled out from the ink inlet/outlet 55.

Waste ink is stored in the fluid chamber 62 of the ink cartridge 17 at this time, and the amount of waste ink flowing into the air chamber 61 can be minimized even if the ink cartridge 17 is turned in the direction enabling the waste ink to flow easily from the fluid chamber 62 through the communication path 58 into the air chamber 61 (the bottom as seen in FIG. 9) because the ribs 91 interfere with the flow of waste ink. Because the plural dividers 71a to 71h in the air chamber 61 are disposed substantially parallel to the direction of waste ink flow from the fluid chamber 62 to the air chamber 61 through the communication path 58, waste ink that has flowed into the air chamber 61 does not move into the buffer chambers 72a to 72h.

Removing waste ink from the foregoing ink cartridge 17 so that the ink cartridge 17 can be reused is described next.

As shown in FIG. 11, the ink cartridge 17 removed from the cartridge loading unit 15 can be positioned so that the other end 53b of the ink path 53 is on the bottom. As a result, the ink path 53 is positioned vertically, and waste ink inside the ink storage unit 45 collects on the other end 53b side of the ink path 53.

An ink suction needle (not shown in the figure) is then inserted to the ink inlet/outlet 55 of the ink cartridge 17 to vacuum ink from the ink cartridge 17. As a result, the waste ink inside the ink storage unit 45 of the ink cartridge 17 is drawn from the other end 53b of the ink path 53 into the ink path 53 and is removed through the ink suction needle. Negative pressure is therefore produced inside the ink cartridge 17, but the negative pressure does not become high and does not interfere with ink suction because air flows in through the outside air channel 87, that is, in the opposite direction as when waste ink flows into the fluid chamber 62.

Furthermore, when the amount of waste ink left in the ink storage unit 45 is slight and the fluid surface of the waste ink is near the inside surface of the frame part 52 disposed at the bottom, even the small amount of waste ink left in the recess 57 can be reliably vacuumed out through the ink path 53 because the other end 53b of the ink path 53 opens inside the recess 57.

After the waste ink is removed from the ink storage unit 45, the ink cartridge 17 can be reused by refilling the ink packs 47 with ink.

Furthermore, whether the ink cartridge 17 described above is oriented as shown in FIG. 11 for removing waste ink from the ink storage unit 45, is inverted to this position, or is placed with the installation face 44 down, waste ink inside the ink storage unit 45 is prevented from flowing to the outside through the outside air channel 87 because the outside air channel 87 is formed around the fluid chamber 62 and the other end 87b thereof, which is the end of the outside air channel 87 open to the outside, is positioned farther from the air chamber 61 than the fluid chamber 62.

Furthermore, because buffer chambers 72a to 72h that each communicate with adjacent chambers are disposed in the air chamber 61 at a position separated from the communication path 58 connecting the air chamber 61 and fluid chamber 62, the flow of waste ink from the fluid chamber 62 into the outside air channel 87 is prevented. In addition, because the vent holes 81 and 82 formed in the divider 71a separating buffer chamber 72a and the space on the communication path 58 side of the air chamber 61 and the dividers 71b to 71e separating the buffer chambers 72b to 72e are disposed in a zigzag pattern in the vertical and thickness directions of the ink cartridge 17, the flow of waste ink through the buffer chambers 72a to 72e is effectively suppressed in all directions.

The flow of waste ink in the fluid chamber 62 into the outside air channel 87 is thus effectively prevented, and the leakage of waste ink to the outside is more effectively prevented.

If waste ink enters the outside air channel 87, the waste ink collects in the air release chamber 88 or the fluid collection chambers 90 formed in the outside air channel 87, and is thus prevented from leaking out from the air escape hole 89.

With the ink cartridge 17 described as a first embodiment of a fluid storage container according to the invention, waste ink can be stored in a waste ink storage unit 41a and ink packs 47 filled with ink can be stored in an ink pack storage unit 41b because a waste ink storage unit 41a and an ink pack storage unit 41b are formed as fluid storage units on opposite sides of a divider 48.

In addition, with the ink cartridge 17 according to this embodiment of the invention the case body 41 in which the recessed waste ink storage unit 41a and ink pack storage unit 41b are formed on opposite sides of the divider 48 has an I-beam shape in cross section with a perimeter wall 49 surrounding the divider 48. As a result, the width of the parts of the perimeter wall 49 forming the waste ink storage unit 41a and ink pack storage unit 41b respectively can be reduced and the strength of the case body 41 can be greatly increased. Damage to the case body 41 when the ink cartridge 17 is dropped or subject to impact can therefore be suppressed, and leakage of waste ink or ink from the waste ink storage unit 41a and ink pack storage unit 41b, respectively, can be prevented.

Furthermore, because the perimeter wall 49 of the case body 41 includes an inside wall 64 and an outside wall 65 connected by a plurality of ribs 66 with a gap G there between, the outside wall 65 can absorb the impact and suppress damage to the inside wall 64 even if the outside wall 65 is damaged as a result of the ink cartridge 17 being dropped or struck, and leakage of fresh ink or waste ink from the waste ink storage unit 41a and ink pack storage unit 41b can be prevented. In addition, because a gap G is rendered in the corners of the case body 41 in anticipation of damage to the outside wall if the ink cartridge is dropped, for example, and positions other than the corners are less susceptible to impact than the corners, the inside wall 64 and outside wall 65 are connected by the ribs 66 to achieve both improved strength and prevent ink leakage.

Yet further, because the divider 48 is disposed within the width W of the IC chip 75 affixed to the perimeter wall 49, the load from the reader/writer can be received by the divider 48 when the reader/writer contacts and energizes the IC chip 75 in order to read or write data to the IC chip 75. As a result, the load on the perimeter wall 49 of the case body 41 can be minimized, deformation of and damage to the perimeter wall 49 by this load can be suppressed, and the leakage of fresh ink or waste ink from the waste ink storage unit 41a and ink pack storage unit 41b can be prevented.

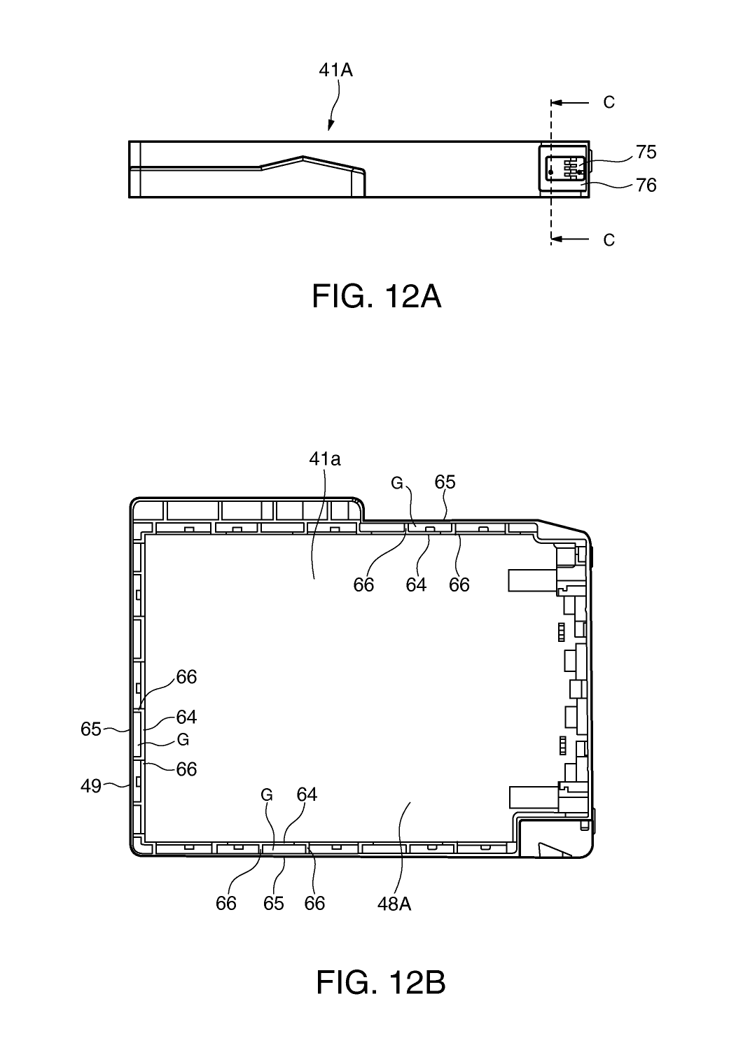

It will be obvious to one with ordinary skill in the related art that the invention is not limited to the foregoing embodiment and can be varied in many ways. For example, the volume of the waste ink storage unit 41a can be reduced because some amount of ink is used for printing, and the volume of the ink pack storage unit 41b can therefore be increased. This configuration is described with reference to FIG. 12 to FIG. 14 below.

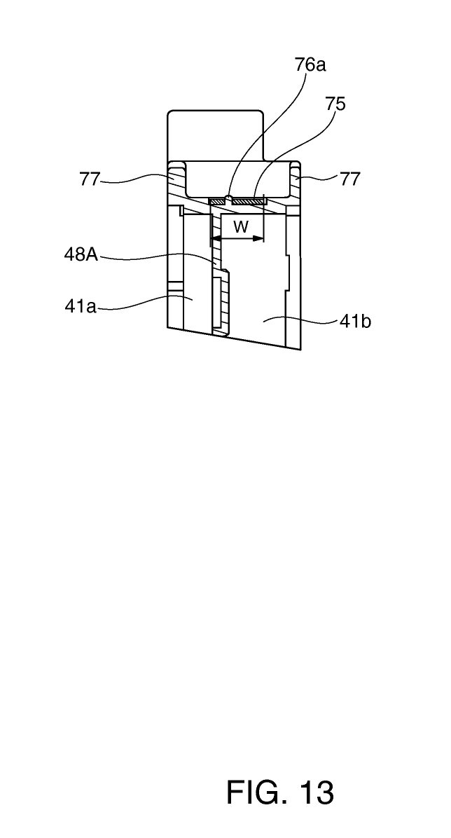

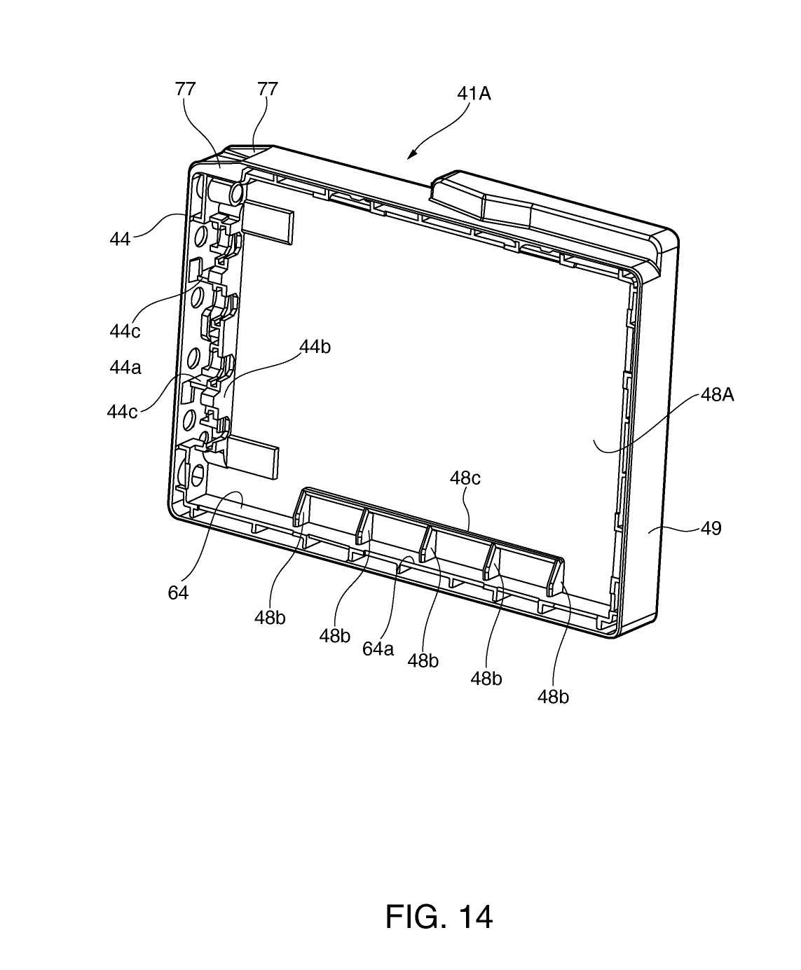

FIGS. 12A and 12B illustrate a case body of an ink cartridge according to a second embodiment of the invention, FIG. 12B being a plan view from the waste ink storage unit side. FIG. 13 is a section view through line C-C shown in FIG. 12A. FIG. 14 is an oblique view of the case body shown in FIGS. 12A and 12B from the ink pack storage unit side.

Note that identical parts and parts having the same function as the first embodiment described above are identified by the same reference numerals in these figures, and further description thereof is omitted or simplified.

As shown in FIG. 12B, an inside wall 64 on the divider 48A side as in the first embodiment, and an outside wall 65 disposed opposite the inside wall 64 with a gap there between, are disposed to three sides of the perimeter wall 49 of the case body 41A. The inside wall 64 and outside wall 65 are connected by ribs 66 disposed around the circumference with a gap there between. The ribs 66 are disposed at positions not including the corners of the case body 41, and a gap G is thus formed between the inside wall 64 and outside wall 65 at the corners of the case body 41.

The divider 48 of the case body 41 in the first embodiment is disposed in the middle of the cartridge thickness, but in this second embodiment as shown in FIG. 13 the recess on the ink pack storage unit 41b side is made deeper and the volume is increased. Even in this configuration, however, the divider 48A is disposed within the width W of the provided IC chip 75.

As a result, when the reader/writer contacts and energizes the IC chip 75 in order to read or write data to the IC chip 75, the load from the reader/writer can be received by the divider 48A, the load on the perimeter wall 49 of the case body 41A can be minimized, and deformation of and damage to the perimeter wall 49 by this load can be suppressed. Note that the boss 76a shown in FIG. 13 is for affixing the IC chip 75 that is disposed to the installation surface of the IC chip 75, and after the IC chip 75 is affixed, the top is deformed and the height is reduced.

In addition, as shown in FIG. 14, a plurality of connecting ribs 48b (connecting units) that connect the intersecting surfaces of the divider 48A and inside wall 64 are disposed with an interval there between in the middle of the ink pack storage unit 41b at what is the bottom thereof when the ink cartridge is installed in the cartridge loading unit 15. A reinforcing rib 48c (connection reinforcement unit) is disposed protruding from the divider 48A so that the reinforcing rib 48c connects the connecting ribs 48b to each other at the top end side of the connecting ribs 48b.

When a plurality of ink packs 47 are stored in the ink pack storage unit 41b, the open side part 64a of the inside wall 64 at the bottom side of the ink pack storage unit 41b that supports the weight of the ink packs may deform to the outside if these connecting ribs 48b are not present. However, by rendering connecting ribs 48b as described in this embodiment, the inside wall 64 is supported by the divider 48A through the connecting ribs 48b and is thus strengthened and made more resistant to deformation. Furthermore, because the divider 48A is supported by the inside wall 64 through the connecting ribs 48b and thereby strengthened, the divider 48A also becomes more resistant to deformation.

Furthermore, the part of the divider 48A supporting the inside wall 64 through the connecting ribs 48b as seen in FIG. 14 may conceivably flex easily forward, but because a reinforcing rib 48c interconnects the connecting ribs 48b protruding from the divider 48A, there may be substantially no deformation resulting from the divider 48A flexing.

Note that connecting ribs 48b and a reinforcing rib 48c are also rendered in the first embodiment as shown in FIG. 6 and function in the same way as described above.

Note that an ink pack installation unit 44b that rises from the divider 48A and has channels into which the valve parts 47b of the stored ink packs 47 are fit and secured, and an installation wall 44a to which the installation face 44 is formed, are connected by connecting ribs 44c in this second embodiment of the invention. The connecting ribs 44c in this configuration prevent deformation of the installation face 44 if the installation face 44 of the ink cartridge 17 is subject to a strong impact such as by being dropped.

In addition to ink cartridges such as used in inkjet printers as described above, the fluid storage container according to the invention can be applied in fluid supply devices use fluid discharge heads for discharging a variety of fluids, including color agent discharge heads used in manufacturing color filters for liquid crystal displays, electrode material discharge heads used for forming electrodes in an organic electroluminescent (EL) display and field emission display (FED) devices, and bio-organic material discharge heads used in biochip manufacture. The invention can also be used in a fluid storage container that is used in a reagent discharge device used as a precision pipette.

The concept of a fluid as used herein also includes gels, high viscosity materials, and mixtures of a solid in a solvent, and the concept of an ink includes aqueous inks and oil-based inks.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims.

What is claimed is:

1. A fluid storage container having a first fluid storage compartment in which fluid can be stored isolated from a second fluid storage compartment in which fluid can be stored, the container comprising:
a case body comprising:
a divider that blocks fluid communication between the first and second fluid storage compartments,
a first perimeter wall comprising an inner wall and an outer wall spaced apart from the inner wall, the first perimeter wall disposed around a perimeter portion of the divider on a first side of the divider, the divider and the first perimeter wall defining a first recess that partially defines the first fluid storage compartment, and
a second perimeter wall comprising an inner wall and an outer wall spaced apart from the inner wall, the second perimeter wall disposed around a perimeter portion of the divider on a second side of the divider opposite to the first side of the divider, the divider and the second perimeter wall defining a second recess that partially defines the second fluid storage compartment;
a first removable cover, the first cover and the first recess defining the first fluid storage compartment when the first cover is coupled with the case body;
a second removable cover, the second cover and the second recess defining the second fluid storage compartment when the second cover is coupled with the case body; and
a connecting rib that connects a surface of the divider and a surface of the inner wall in at least one of the first or second fluid storage compartments.

2. The container of claim 1, wherein the connecting rib is disposed on a bottom side of the container when the container is oriented to supply fluid.

3. The container of claim 2, further comprising at least one additional connecting rib that connects a surface of the divider and a surface of the inner wall in at least one of the first or second fluid storage compartments, a plurality of said connecting ribs being disposed in a row and connected together by a connection reinforcement unit formed on the divider.

4. The container of claim 3, further comprising a device having a width and storing data disposed to an outside surface of the case body, wherein the divider is connected to a portion of the case body partially defined by the outside surface within the width of the device.

5. The container of claim 1, further comprising a device having a width and storing data disposed to an outside surface of the case body, wherein the divider is connected to a portion of the case body partially defined by the outside surface within the width of the device.

6. The container of claim 1, wherein the container stores ink and is configured to couple with a printing device to supply ink to the printing device and store waste ink received from the printing device.

7. A fluid storage compartment having a first orientation facilitating reception of a fluid into the storage compartment and a second orientation facilitating removal of the fluid from the storage compartment, the storage compartment comprising:
a case body; and
a cover coupled with the case body, the combination of the case body and the cover at least partially defining the storage compartment, at least one of the cover or the case body comprising a plurality of walls extending between the cover and the case body to divide the storage compartment so as to define:
an inlet channel having a first end and a second end, the first end in fluid communication with a fluid port disposed along a first side of the storage compartment, the inlet channel configured to transport the fluid received at the first end and discharge the fluid at the second end when the storage compartment is in the first orientation,
a recess disposed along a second side of the storage compartment opposite to the first side of the storage compartment, the second end of the inlet channel being disposed within the recess,
a fluid collection chamber in fluid communication with the recess and disposed at least partially below the recess when the storage compartment is in the first orientation and disposed generally above the recess when the storage compartment is in the second orientation, and
a series of buffer chambers in fluid communication with the recess and disposed generally above the recess when the storage compartment is in the first and second orientations, the buffer chambers being in fluid communication with an air escape hole to vent the storage compartment.

8. The storage compartment of claim 7, wherein a first chamber of the buffer chambers is in fluid communication with an adjacent second chamber of the buffer chambers via a vent hole disposed in one of the walls disposed between the first and second buffer chambers.

9. The storage compartment of claim 8, wherein:
each of a plurality of the buffer chambers is in fluid communication with an adjacent chamber of the buffer chambers via a vent hole disposed in one of the walls disposed between the chambers;
one of the vent holes is disposed above another of the vent holes when the storage compartment is in the first orientation; and
the walls have a thickness dimension that extends between a surface of the case body and a surface of the cover and two of the vent holes are disposed at different thickness dimensions.

10. The storage compartment of claim 7, wherein the cover comprises a vent channel that places a first of the buffer chambers in fluid communication with a second of the buffer chambers.

11. The storage compartment of claim 10, wherein the cover comprises a plurality of vent channels and each of a plurality of the buffer chambers is in fluid communication with another of the buffer chambers via one of the vent channels.

12. The storage compartment of claim 7, wherein the plurality of walls define a plurality of ribs disposed in the fluid collection chamber that are substantially horizontally oriented and configured to impede flow of the fluid from the fluid collection chamber to the buffer chambers when the storage compartment is in the first orientation while allowing the fluid to flow from the fluid collection chamber to the recess when the storage compartment is in the second orientation.

13. The storage compartment of claim 7, wherein the air escape hole is disposed near the bottom of the storage compartment when the storage compartment is in the first orientation and the plurality of walls define an outside air channel disposed along a perimeter of the storage compartment that places the buffer chambers in fluid communication with the air escape hole.

14. The storage compartment of claim 13, wherein the plurality of walls define a second fluid collection chamber in fluid communication with the outside air channel via an opening disposed at the top of the second fluid collection chamber when the storage compartment is in the first orientation.

15. The storage compartment of claim 14, wherein the plurality of walls define a third fluid collection chamber in fluid communication with the outside air channel via an opening disposed at the top of the third fluid collection chamber when the storage compartment is in the first orientation.

16. The storage compartment of claim 7, wherein the plurality of walls are integral to the cover.

17. The storage compartment of claim 7, wherein the compartment is configured to couple with a printing device and stores waste ink received from the printing device.
